(19) United States
(12) Patent Application Publication
(10) Pub. No.: US 2007/0097151 A1
(43) Pub. Date: May 3, 2007

(54) BEHIND-SCREEN ZOOM FOR HANDHELD COMPUTING DEVICES

(75) Inventor: Louis B. Rosenberg, Pismo Beach, CA (US)

Correspondence Address: SINSHEIMER JUHNKE LEBENS & MCIVOR, LLP, 1010 PEACH STREET, P.O. BOX 31, SAN LUIS OBISPO, CA, 93406, US

(73) Assignee: OUTLAND RESEARCH, LLC, Pismo Beach, CA (US)

(21) Appl. No.: 11/626,355

(22) Filed: Jan. 23, 2007

Related U.S. Application Data
(60) Provisional application No. 60/790,024, filed on Apr. 7, 2006.

(51) Int. Cl. G09G 5/00

(52) U.S. Cl. 345/660

(57) ABSTRACT

A portable computing device provides behind screen zooming. A display screen is disposed upon a frontal surface of the portable computing device. A rear-mounted manual control is disposed upon a rear surface of the portable computing device and is positioned at a location directly behind at least a portion of the display screen such that a user viewing the display screen while pressing upon the rear-mounted manual control is provided with an illusion of pressing upon the backside of the display screen. A detector detects a finger interaction upon the rear-mounted manual control. A processor enlarges an image displayed upon the display screen in response to and time-synchronized with the detected finger interaction upon the rear-mounted manual control. The enlarging is coordinated with the finger interaction so as to provide an illusion that the user is pushing upon the image from behind thereby causing it to zoom-in.

### RELATED APPLICATION DATA

This application claims priority to provisional application Ser. No. 60/790,024, filed Apr. 7, 2006, the disclosure of which is hereby incorporated by reference herein in its entirety.

### FIELD OF THE APPLICATION

The present invention relates to a zoom functions for graphical user interfaces (GUIs) of portable computing devices.

### BACKGROUND

A common function supported by most GUIs of the current art is a zoom function. The zoom function is one in which a visually displayed document, or a portion thereof, is enlarged upon a display screen, giving the illusion that it has been brought closer to the user. A zoom function is important in many situations in which a user wishes to look carefully upon a displayed document, focusing upon small details. For example, geographic mapping software often uses a zoom function in which a user can enlarge the size of a displayed map as if it were brought closer to the user's eye. This is generally referred to as “zooming-in.” Alternately, a user may wish to reduce the displayed size of a graphical document, such as a map, such that a large portion of the document fits upon the screen. This is generally referred to as “zooming-out.” Thus, in geographic mapping software a user may use a zoom function to selectively scale the size of the displayed map upon the screen, allowing the user to zoom-in upon a local region (e.g., a particular town or street or house), or zoom-out upon a larger geographic region (e.g., a whole state, country, or even the whole earth). While geographic mapping is used as the example by which a zoom function is described, the function is useful in a great many applications that involve graphical and/or textual information display, including but not limited to word processing, graphic design, web browsing, and other general purpose document browsing tools.

The zoom function is enabled by computing applications is generally controlled by a user through a GUI in which a user may selectively zoom-in or zoom-out upon the document. For example, the document may be zoomed-in or zoomed-out by clicking upon a certain GUI element and/or performing a certain manual gesture. In some applications such as, for example, Adobe Acrobat™, a user zooms-in by manually selecting a magnifying glass icon and then clicking upon the document in a location at which zoom is desired. In Microsoft Word™, a user zooms-in by manually selecting a percentage zoom value from a pull down menu. In other applications, a zoom function may be controlled by clicking upon an alternate icon, by adjusting a graphical slider, or by otherwise performing a manual gesture. In some instances the zoom function happens in incremental steps, with one step for each click or gesture. In other instances the zoom function happens continuously based upon the distance a graphical element is slide across the screen and/or the time duration that a GUI element is engaged. For example, in the mapping application Google Earth™, the user may zoom-in upon a geographic model of the planet earth by clicking upon a graphical (+) icon, whereby the longer the button is held the more it zooms-in. Alternately, Google Earth™ allows a graphical slider to be adjusted upon the screen, whereby the distance and duration at which the slider is displaced, the faster and longer the zoom operation.

Some new zooming methods have recently been disclosed by Apple Computer™ in which a user performs a multi-finger gesture upon a touch screen to enable a zoom function. As disclosed in U.S. Patent Application Publication No. 2006/0026536 which is hereby incorporated by reference, a multi-finger gesture is enabled upon a touch screen such that the amount of zoom is dependent upon the user spreading apart two finger placed upon the screen, and the further the fingers spread, the more the displayed image is zoomed. As disclosed in U.S. Patent Application Publication No. 2006/0022955 which is also hereby incorporated by reference, a local area zoom is enabled upon a touch screen by sliding a finger over a surface of a touch screen and selectively magnifying an area near the finger contact. As disclosed by Nokia™ in U.S. Patent Application Publication No. 2006/0017711, which is also hereby incorporated by reference, a handheld computing device has been devised with an off-screen hardware slider bar (i.e., a touch sensitive strip) that is mapped to a zoom function. This emulates an on-screen slider control for zooming without taking up on-screen space. Other systems have also provided off-screen controls for zooming, such as the scroll whereby a mouse which may be mapped to zooming functions in some applications.

Overall, a variety of different zooming methods have been devised by developers of the current art, but all are believed to suffer from a similar limitation—they provide an unnatural mapping between user manual input and the zooming function. This is because a zooming function emulates a physical process by which a document is brought closer to the user and yet the physical action performed by the user does not involved an action that physically emulates bringing a document closer to the user. For example, pressing or clicking upon an icon upon the screen does not physically emulate bringing a document closer and thus provides an unnatural abstract mapping. Similarly, sliding a graphical element horizontally or vertically upon a screen does not physically emulate bringing a document closer and thus is an unnatural abstract mapping. Rotating a scroll where upon a mouse does not physically emulate bringing a document closer provides an unnatural abstract mapping. Similarly, manipulating an off-screen slider strip that runs horizontal or vertical with respect to the plane of the screen does not physically emulate bringing a document closer and thus is an unnatural abstract mapping. Moreover, spreading two fingers apart upon a touch screen does not physically emulate bringing a document closer and thus is an unnatural abstract mapping. In addition, spreading two fingers upon a touch screen has the additional problem that the user's fingers block his or her view of the document being zoomed. What is therefore needed is a user interface method and apparatus that provides a more natural mapping between user manual inputs and bringing a document closer. What is also needed is a natural mapping between manual inputs and bringing a document closer that does not cause a user's own fingers to block his or her view of the document being zoomed. What is further needed is a user interface method that is particularly well adapted for handheld devices in which the user must use one or both hands to support the computing device as well as interact with it.

### SUMMARY

Embodiments of the present invention comprise methods and apparatus for enabling the user of a portable computing device to zoom-in upon a displayed document through the enactment of natural and intuitive manual interactions. More specifically, embodiments of the present invention comprise a portable computing device that includes a handheld portion. The handheld portion includes a frontal surface that includes a display screen that is exposed for viewing by the user. The handheld portion also includes a rear surface that is positioned on the opposite side of the display screen (i.e., the back side of the handheld portion as compared to the viewing side). A manual control is positioned upon the rear surface such that to the perspective of the user, the manual control is located behind the display screen. In this way, a user who places his or her finger upon the behind-screen manual control is given the illusion that he or she is placing his or her finger at a location that behind the displayed document. More specifically, the user may be given the illusion that he or she is placing his or her finger upon the rear surface of the displayed document.

Embodiments of the present invention further include a local processor and local software routines operative to display a document that may be selectively zoomed-in by the user through interaction with the manual control. Thus, embodiments of the present invention include a manual control interface positioned behind the display screen of a handheld computing device, where the manual control is operative to detect a user's finger interaction and zoom the displayed document in response. In this way a user may hold the portable computing device and apply finger pressure behind the screen, and is given the perceptual illusion that he or she is pushing upon the displayed document from behind. This causes the displayed document to zoom-in upon the handheld screen of a portable computing device. In this way the user may hold the portable computing device and apply finger pressure behind the screen, thereby causing the document to zoom-in. This provides the user with the perceptual illusion that he or she is bringing the document towards him or her (i.e., zooming it forward) in response to pushing upon the document from behind. This provides a natural and intuitive mapping between manual interaction and the zooming operation. This also enables a user to zoom-in a document through a manual interaction that does not cause the user's hand to block his or her view of the zoomed document. This also enables the user to zoom-in a document using a handheld computing device through a gesture that is easily performed while simultaneously holding the portable computing device. This is because the hand of the user that is positioned to support the handheld computing device may also be used to apply pressure from behind and thereby zoom the document. The user's alternate hand may thus be free for other screen interactions, such as pointing and selection of graphical user interface elements.

In some embodiments of the present invention the behind screen manual control is a finger responsive element that is positioned at a certain location behind the display screen. In the behind-screen manual control may be a finger response surface that substantially covers the same planar area upon the rear surface as the screen covers upon the frontal surface. The finger responsive surface may be a touch pad positioned behind the screen as a plane parallel to the screen on the reverse surface of the handheld portable computing device. In some embodiments of the present invention the entire displayed document is caused to zoom-in when the user presses upon the behind-screen manual control. In some embodiments, the point that is being zoomed in towards (i.e., the focal point of the zoom function) is the location upon the screen that is directly in front of the location at which the user is engaging the behind-screen manual control.

In some embodiment of the present invention, only a local portion of the displayed document is caused to zoom-in when the user presses upon the behind-screen manual control. That local portion corresponds to an area of the display screen that is in front of the user's finger (or substantially in front of the user's finger) as he or she presses upon the real surface. In some such embodiments, the displayed document is deformed such that the area substantially in front of the user's finger is expanded (i.e., zoomed) while other areas are compressed. The displayed document may be made to seem like an elastic sheet. The user presses upon the elastic sheet from behind, thereby stretching (i.e., zooming) the area he or she is pressing upon.

In some embodiments of the present invention, the user may only zoom-in the document by pressing upon the behind-screen manual control at a designated location or within a designated area. The user may only zoom-in the document by pressing upon the behind-screen manual control with more than a certain threshold of force in some embodiments. In some embodiments, the user may only zoom-in the document by pressing upon the behind-screen manual control for a time duration that exceeds a certain threshold time. In some embodiments, the user may only zoom-in the document by pressing upon the behind-screen manual control with more than a certain threshold of force and for more than a certain threshold of time. In some embodiments, the user may only zoom-in upon the document by performing a certain multi-finger gesture upon the behind-screen manual control such as, for example, pressing with two fingers simultaneously upon the behind-screen manual control.

In some embodiments, the amount by which the document is zoomed-in is dependent upon the duration for which the user applies a force upon the behind-screen manual control. In some embodiments of the present invention, the amount by which the document is zoomed-in is dependent upon the duration for which the user applies a force that is above a certain threshold upon the behind-screen manual control. In some embodiments, the amount by which the document is zoomed-in is dependent upon the level of force applied by the user upon the behind-screen manual control. The method and apparatus may be further operative to enable a user to zoom-out by pressing upon an on screen manual control (e.g., a touch screen interface). In some such embodiments the user may zoom-in and zoom-out based upon the difference in pressure applied to a behind screen manual control and an on-screen manual control. The direction of the zoom function may be dependent upon the difference in pressure applied to a behind screen manual control and an on-screen manual control being greater than a certain threshold. In some such embodiments, the speed of the zooming function is dependent upon the difference in pressure applied to a behind screen manual control and an on-screen manual control. In some such embodiments a graphical icon is drawn upon the screen as a reference for where upon both the frontal surface and the rear surface the user is to press to perform the zooming control.

In some embodiments of the present invention, the displayed document or object can be tilted by pressing upon the behind-screen manual control at one edge of the document or object and thereby bringing that edge of the document or object forward, while the opposite edge of the document or object does not come forward.

In some embodiments a displayed graphical object is a virtual globe. In such embodiments the user can rotate the globe by swiping his or her finger across it from behind. The displayed globe rotate upon the screen in the opposite direction to the user swiping motion, as the user is giving the illusion that he or she is swiping the back side of the globe. This allows a user to manipulate a virtual globe in a natural and intuitive manner without blocking it with his or her fingers. In some such embodiments the user may bring the displayed globe closer (i.e., zoom-in upon it) by pressing upon the globe from behind using the behind-screen manual control. In some such embodiments the displayed globe is generated by the Google Earth™ software application, the Microsoft Virtual Earth™ software application, or a similar software application. In this way a user many selectively rotate and zoom a virtual globe using a behind-screen manual control. In some embodiments a multi-finger behind screen gesture is used to initiate and control the globe rotate and/or globe zoom function. For example, two or three fingers pressed simultaneously on the reverse surface of the globe can be configured to cause the rotation and/or zooming function.

The above summary of the present invention is not intended to represent each embodiment or every aspect of the present invention. The detailed description and figures will describe many of the embodiments and aspects of the present invention.

### BRIEF DESCRIPTION OF THE DRAWINGS

The above and other aspects, features and advantages of the present embodiments will be more apparent from the following more particular description thereof, presented in conjunction with the following drawings wherein:

FIG. 1 illustrates a portable computing device configured to be held by a user in one or both hands according to at least one embodiment of the invention;

FIG. 2A illustrates a portable computing device that includes a handheld portion according to at least one embodiment of the invention;

FIG. 2B illustrates the reverse side of the portable computing device according to at least one embodiment of the invention;

FIG. 3A illustrates the portable computing device displaying a geographic mapping image generated by an application such as Google Earth™ according to at least one embodiment of the invention;

FIG. 3B illustrates the portable computing device displaying a zoomed-in image of the planet earth according to at least one embodiment of the invention;

FIG. 4 illustrates graphical shadow elements according to at least one embodiment of the invention;

FIGS. 5A and 5B illustrate the zoom-in function according to at least one embodiment of the invention;

FIG. 6 illustrates a local zoom feature using an elastic screen metaphor and a behind screen interface according to at least one embodiment of the invention;

FIG. 7 illustrates a zoom icon according to at least one embodiment of the invention; and

FIG. 8 illustrates a portable computing device for provides behind screen zooming according to at least one embodiment of the invention.

Corresponding reference characters indicate corresponding components throughout the several views of the drawings. Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention.

### DETAILED DESCRIPTION

Embodiments of the present invention provide a natural and intuitive method by which a user may zoom a displayed document upon a portable computing device using touch interactions. More specifically, embodiments of the present invention comprise a handheld portable computing device configured with a display screen upon a frontal surface of the device and a manual control positioned behind the display screen upon a rear surface of the device. The rear surface is substantially parallel to the frontal surface. Even more specifically, the embodiments of the present invention provide a unique zooming paradigm in which a user presses upon the behind-screen manual control to zoom-in upon a displayed document, thereby giving the user the illusion that he or she is zooming the displayed document by pressing upon the document from behind. In this way, the displayed document may be zoomed in upon using a more natural manual interaction that more closely maps to the act of bringing a document closer to the user. Additionally, the embodiment enables a zoom-in operation to be performed in a manner such that the user's own fingers do not block his or her view of the document being zoomed.

Embodiments of the present invention are directed at providing a more natural mapping upon portable computing devices that include a handheld display screen. Embodiments of the present invention are also directed at providing a natural mapping between finger motion and zooming such that the user's finger does not block the display screen. Embodiments of the present invention are also directed at providing a user interface method for zooming that is particularly well adapted for use with handheld computing device in which the user must use one or both hands to support the computing device as well as interact with it.

Embodiments of the present invention provide a natural mapping between user manual interaction and a zoom-in function upon portable computing devices that include a handheld display screen. A method of finger-initiated zooming upon portable computing devices is provided such that the user's finger does not block the user's view of the display screen. Embodiments of the present invention are also directed at a finger-initiated zooming method that is particularly well adapted for use with handheld computing device in which the user must use one or both hands to support the computing device. These and other benefits of the present invention are made apparent with respect to the figures and description herein.

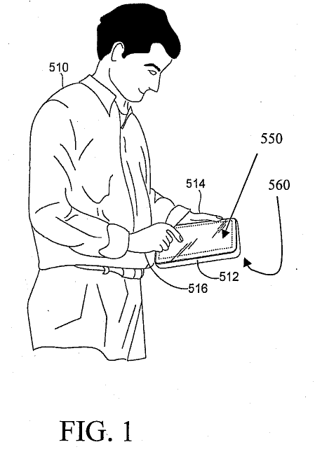

FIG. 1 illustrates a portable computing device 512 configured to be held by a user 510 in one or both hands (514, 516) according to at least one embodiment of the invention. During the moment depicted by FIG. 1, the user 510 is supporting the portable computing device 512 with his left hand 514 and interacting with a touch screen of the portable computing device with his right hand 516. The touch screen is integrated into the frontal surface 550 of the portable computing device and is configured as both a display screen and a manual control for user input. The frontal surface 550 is that surface which faces the user during handheld use. In this way the user 510 can view displayed information upon the screen of frontal surface 550. The user 510 can also provide manual input to the computing device upon the frontal surface 550 through the functionality of the touch screen. The opposite surface of the portable computing device (i.e., the rear face of the device that is positioned away from the user's view during handheld use) is referred to herein as the “rear surface” of the portable computing device and is referenced by reference 560. As shown, the user's left hand 514 that supports the portable computing device 512 is situated such that it supports the weight of the portable computing device 512 and is positioned such that one or more fingers may engage the rear surface 560. Embodiments of the present invention take advantage of this natural support posture by providing a manual control interface (not shown) upon the rear surface 560 of the portable computing device such that the user may engage the manual control while holding the portable computing device 512. From the user's perspective, this manual control is positioned behind the display screen and is referred to herein as a behind-screen manual control. Embodiments of the present invention thus provide a behind-screen manual control that enables the user 510 of a portable computing device to provide manual input upon a rear surface 560 that is behind the display screen. The embodiments of the present invention also provide unique methods and software routines such that the user may zoom-in upon documents displayed upon the display screen by pressing upon the behind-screen manual control. In this way the user 510 is given the illusion of zooming-in upon a displayed document by pressing upon that document from behind.

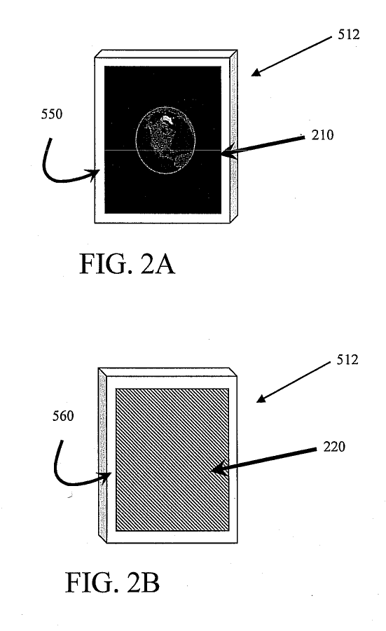

In this way, embodiments of the present invention comprise methods and apparatus for enabling the user 510 of a portable computing device 512 to zoom-in upon a displayed document through natural manual interactions upon a behind-screen manual control. FIG. 2A illustrates a portable computing device 512 that includes a handheld portion according to at least one embodiment of the invention. The handheld portion includes the frontal surface 550 that includes a display screen 210 that is exposed for viewing by the user. As shown in the figure, the display screen depicts a graphical image. FIG. 2B illustrates the reverse side of the portable computing device according to at least one embodiment of the invention. As depicted, the rear surface 560 is positioned on the opposite side of the display screen (i.e., the back side of the handheld portion as compared to the viewing side). A manual control 220 is positioned upon the rear surface 560 such that to the perspective of the user, the manual control is located behind the display screen. This manual control 220 is referred to herein as the “behind-screen manual control.” In FIG. 2B, control 220 is a planar manual control such as a touch pad. The touch pad is positioned directly behind the screen surface. In this way, a user who places his or her finger upon the behind-screen manual control is given the illusion that he or she is placing his or her finger at a location that behind the displayed document. More specifically, the user may be given the illusion that he or she is placing his or her finger upon the rear surface of the displayed document. In this way, the user who engages the behind screen manual control 220 is given the illusion that he or she is touching the displayed document upon screen 210 from behind the document.

Embodiments of the present invention further include a local processor and local software routines operative to display a document that may be selectively zoomed-in by the user through interaction with the behind-screen manual control 220. Thus, the embodiments of the present invention include a manual control interface positioned behind the display screen of a handheld computing device, where the manual control operative to detect a user's finger interaction and in response to the detection, zoom the displayed document. In this way the user may hold the portable computing device and apply finger pressure behind the screen, giving the perceptual illusion that he or she is pushing upon the displayed document from behind. This causes the displayed document to zoom-in upon the handheld screen of a portable computing device.

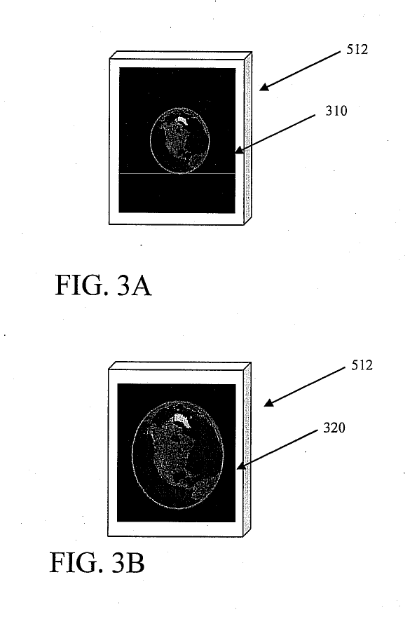

FIG. 3A illustrates the portable computing device 512 displaying a geographic mapping image generated by an application such as Google Earth™ according to at least one embodiment of the invention. The image 310 is of the planet earth and is shown at a certain current level of zoom. The user may hold the portable computing device and apply finger pressure behind the screen as described previously. In response to the applied finger pressure, software routines of the present invention cause the document to zoom-in.

FIG. 3B illustrates the portable computing device 512 displaying a zoomed-in image of the planet earth according to at least one embodiment of the invention. As shown, the image 320 is of the planet earth depicted at a larger size upon the screen as a result of the zoom-in function. Thus, embodiments of the present invention enable the user to zoom-in upon the displayed document by applying finger pressure upon a behind-screen manual control that is positioned behind the display screen. This provides the user with the perceptual illusion that he or she is bringing the document towards him or her (i.e., zooming it forward) in response to pushing upon the document from behind. This creates a natural and intuitive mapping between manual interaction and the zooming operation. This also enables a user to zoom-in a document through a manual interaction that does not cause the user's hand to block his or her view of the zoomed document. This further enables the user to zoom-in a document using a handheld computing device through a gesture that is easily performed while simultaneously holding the portable computing device. This is because the hand of the user that is positioned to support the handheld computing device may also be used to apply pressure from behind and thereby zoom the document. The user's alternate hand may thus be free for other screen interactions, such as pointing and selection of graphical user interface elements.

A person of ordinary skill in the art would readily appreciate that a range of intermediate images may be displayed as the image transitions from FIG. 3A to FIG. 3B as a result of the zoom function. For example, the user may see the image continuously enlarge from the view depicted in image 310 to the view depicted in image 320. This continuous enlargement (i.e., the zooming function) may occur throughout the duration of the user's engagement upon the behind-screen manual control, the longer the engagement the more the image is zoomed-in. This speed of the enlargement (i.e., the zooming function) may be constant or may be dependent upon the level of pressure applied to the behind-screen manual control. In this way the user may control not just the zooming function, but the speed of the zooming function, by applying pressure to the behind screen manual control. In some embodiments the zooming function is not initiated by the software unless the pressure applied to the behind screen manual control exceeds a certain level threshold. In some embodiments the zooming function is not initiated by the software unless the pressure applied to the behind screen manual control is applied for more than a certain threshold amount of time.

In some embodiments of the present invention the behind screen manual control is a finger responsive element that is positioned at a certain location behind the display screen. For example, the finger responsive element may be a touch sensitive pad that is located at discrete location behind the screen that is easily engaged by a finger of the user as he or she supports the portable computing device with hand. In some embodiments the touch sensitive pad is an analog sensor that reports a contact value based upon a level of force or pressure applied by a finger of the user. Thus, with respect to FIG. 1, the behind screen manual control may be a touch sensitive pad that is located behind the display screen such that it may be easily engaged by a finger of support hand 514. In some such embodiments, the behind-screen touch sensitive pad may be able to sense engagement by a plurality of different fingers of hand 514. The behind-screen touch sensitive pad may be configured such that it can distinguish between a single finger touch and a multi-finger touch. The behind screen touch sensitive pad may be configured to distinguish which of a plurality of different fingers of hand 514 is engaging the pad, for example based upon the location of the engagement.

In some embodiments of the present invention, the behind-screen manual control is a finger responsive surface that substantially covers the same planar area upon the rear surface of the portable computing device as the display screen covers upon the frontal surface of the portable computing device. In many embodiments, the finger responsive surface reports a numerical value indicative of the spatial location of user finger placement upon the planar area. Such a finger responsive surface is often referred to as a “touch pad interface” and may be enabled through methods known to the art. An example of such a touch sensitive planar area positioned upon the rear surface of a portable computing device is depicted in FIG. 2B as element 220. In some embodiments the touch sensitive surface is an analog sensor that also reports an analog contact value based upon a level of force and/or pressure applied by a finger of the user. In this way, the touch sensitive pad may report values that indicate both the location of finger contact and the force level of finger contact. In some such embodiments, multiple such values may be reported for multiple finger contacts. It should be appreciated that in many preferred embodiments the locative mapping between finger contact location upon the touch sensitive surface and the graphical elements displayed upon the screen is such that each finger contact location upon the rear surface is relationally mapped to the screen location upon the frontal surface that is located directly in front of that finger contact location.

Thus, in some embodiments of the present invention, the finger responsive surface is a touch pad interface that is positioned on the rear surface of the computing device such that it is directly behind the screen of the computing device, the plane of the finger responsive surface being substantially parallel to the plane of the screen of the computing device. It may be particularly beneficial if the computing device is substantially thin in width such that the distance between the plane of the screen and the plane of the finger responsive surface is minimized. For example, the width of the computing device is beneficially configured such that it is substantially less than one inch. In some preferred embodiments it is less than a half-inch. Such a thin width enhances the illusion that a user who touches the rear surface of the computing device is in fact touching the displayed document from behind.

To further enhance the illusion, some embodiments of the present invention are configured in software to display a graphical element upon the display screen that indicates the location of the user's finger upon the behind-screen manual control. Such embodiments generally employ the mapping described previously in which finger contact location upon the behind-screen manual control are correlated with graphical display locations upon the screen that are substantially in front of the finger touch location. By using this mapping, the software may be configured to display a graphical element that indicates a behind-screen finger contact at a screen location that is substantially in front of the location where the finger is contacting the behind-screen manual control. The graphic element may be a standard cursor or a unique element disclosed herein that helps further enhance the illusion that the user is touching the displayed document from behind. In one such embodiment the graphical element is a shadow that represents the approximate size and shape of the finger contact area imparted by the user upon the behind-screen manual control. Thus, as the user moves his or her finger to different locations upon the behind-screen manual control, the graphical shadow element is displayed in real time at an on-screen location that is substantially in front of the then current behind-screen finger contact location.

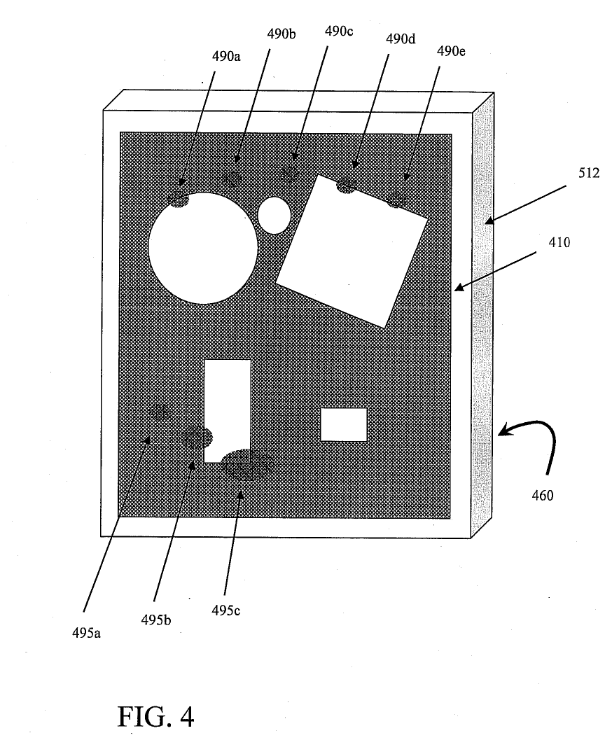

FIG. 4 illustrates graphical shadow elements according to at least one embodiment of the invention. As represented by FIG. 4, a user is holding portable computing device 512 and engaging a behind screen manual control on rear surface 460. The behind-screen manual control is a touch-responsive surface of similar size to display screen 410 and is located substantially behind the display screen in a substantially parallel orientation plane. At a first point in time, the user's finger is a first location upon the behind-screen manual control and is applying a pressure that is greater than a defined magnitude. The software detects the finger contact, determining both the location and magnitude of the contact. A locative coordinate is determined for the placement of the touch contact upon the touch sensitive surface. The software assesses the magnitude of the touch contact and determines that it is greater than a defined threshold level. In response to this determination, the software of the present displays a graphical shadow 490a upon the display screen at a screen location that is substantially in front of the behind-screen touch contact location. The graphical shadow is drawn with a size and shape that emulates how the finger is contacting the behind-screen surface. The graphical shadow is a semi-transparent element, enabling a user to see other graphical elements through it. Because of the size, shape, location, semi-transparent nature of the graphical shadow element 490a, the user is given a convincing illusion that he or she is touching the displayed graphical document from behind. The display of the contact area may be configured to be somewhat similar to how a user might view his or her finger as it contacts a real sheet of glass from behind. In this way the graphical shadow follows a real-world metaphor and is immediately understandable to most users as a natural and intuitive mapping of finger manipulation upon the rear surface of the display screen. A person of skill in the art would readily appreciate that although the graphical shadow 490a is rendered as a semi-transparent area that is darker in shade than the graphical document it is overlaid upon, alternate embodiments may employ a graphical shadow element that is rendered lighter in shade than the graphical document is overlaid upon.

As the user moves his or her finger across the behind-screen control surface, the displayed graphical shadow element is rapidly and repeatedly moved to new locations upon the display screen, where the new locations are substantially in front of the behind-screen location of the moving behind-screen touch contact. Thus, at a second point in time, the user's finger is at a second location upon the behind-screen manual control and is still applying a pressure that is greater than the defined magnitude. The software detects the updated finger contact and determines both the updated location and current magnitude of the contact. A locative coordinate is determined for the new location of the touch contact upon the touch sensitive surface. The software assesses the magnitude of the touch contact and determines that it is still greater than the defined threshold level. In response to this determination, the software displays an updated graphical shadow 490b upon the display screen at a screen location that is substantially in front of the then current behind-screen touch contact location. The graphical shadow is again drawn with a size and shape that emulates how the finger is contacting the behind-screen surface. The graphical shadow is again drawn in a semi-transparent manner.

This process repeats as the user moves his or her finger to new locations upon the touch screen. As the user slides his finger across the behind screen manual control it appears to the user as if the shadow is sliding across the rear side of the document in direct locative correlation with the user's finger sliding across the behind-screen manual control. A number of snapshots are shown for the shadow at a third, fourth, and fifth moment in time as graphical shadow element 490c, 490d, and 490e respectively.

In some embodiments of the present invention, the size and/or shape and/or orientation of the graphical shadow element may be dependent upon the magnitude and/or detected area of finger contact upon the behind-screen manual control. For example, the behind-screen manual control may be a touch pad surface with the ability to detect a contact magnitude and/or a contact area for a finger contact. This data may be used to modify the size and/or shape and/or color and/or transparency of the corresponding graphical shadow element drawn upon the screen. In this way a finger-tip contact upon the behind-screen manual control may be displayed as a graphical shadow with a size and/or different shape and/or orientation than a finger-pad contact upon the control, which is generally larger in contact area and oriented orthogonally. Similarly, an index finger contact upon the behind-screen manual control may be displayed by the software of the present invention as a graphical shadow with a size and/or different shape and/or orientation than a pinky or thumb contact upon the control (or other fingers). This is particularly useful for multi-point behind-screen manual controls that may detect multiple fingers simultaneously. By displaying graphical shadows that appear different for different fingers, a user can more easily distinguish which finger corresponds to which behind screen contact.

It should be appreciated that with respect to the above example of the user sliding the finger across the behind screen manual control, the software is generally configured to make the graphical shadow element disappear if the user lifts his finger form the behind screen touch sensitive surface. This is different from a traditional cursor that generally remains upon the screen when a user lifts his or her hand from a mouse, touch pad, or other user interface device. The removal of the graphical shadow is performed by the software of the present invention to further strengthen the illusion that the user is actually touching the displayed document from behind and that graphical shadow is in fact the user seeing his or her finger contact through the display.

In some embodiments of the present invention, the size and/or shape and/or orientation of the graphical shadow element may be dependent upon the force and/or pressure of the user's finger contact upon the behind-screen manual control. For example, the behind-screen manual control may be a touch pad surface with the ability to detect a contact pressure level for a finger contact. This data may be used to modify the size and/or shape and/or color and/or transparency of the corresponding graphical shadow element drawn upon the screen. In one particular embodiment, the size of the graphical shadow element is drawn larger in response to a larger detected pressure level for the finger contact. An example of such a process is shown in FIG. 4 with respect to a sixth, seventh, and eighth moment in time. At the sixth moment in time, the user contacts the behind screen manual control with a finger at a sixth location and applies a first pressure level. In response to the detected finger contact, the software of the present invention displays graphical shadow element 495a at a location that is substantially in front of the then current behind screen contact location. The graphical shadow element is displayed with a first size. The user then moves his hand and applies increasing pressure. At a seventh moment in time, the user contacts the behind screen manual control with a finger at a seventh location and applies a second pressure level. The second pressure level is greater than the first pressure level. In response to the detected finger contact, the software of the present invention displays graphical shadow element 495b at a location that is substantially in front of the then current behind screen contact location. The graphical shadow element is displayed with a second size that is greater than the first size as a result of the second pressure level being greater than the first pressure level. In this way the user is given the illusion that his or her increased pressure has increased the size of the touch contact area upon the rear surface of the display. At an eighth moment in time, the user contacts the behind screen manual control with a finger at an eighth location and applies a third pressure level. The third pressure level is greater than the second pressure level. In response to the detected finger contact, the software displays graphical shadow element 495c at a location that is substantially in front of the then current behind-screen contact location. The graphical shadow element is displayed with a third size that is greater than the second size as a result of the third pressure level being greater than the second pressure level. In this way the user is given the illusion that his or her increased pressure has increased the size of the touch contact area upon the rear surface of the display. Although these are shown as discrete time steps, to the user they are generally presented as a smoothly continuous action.

As described above, some embodiments of the present invention are configured such that the full displayed document is caused to zoom-in when the user presses upon the behind-screen manual control in a particular way. The amount and/or speed of the zoom-in upon the displayed document may be modulated based upon the measured level of finger contact in terms of force and/or pressure. An example of such an embodiment is shown in FIGS. 3A and 3B, for as the user presses the behind-screen manual control, the image zooms-in, transitioning over a period of time from the view depicted in FIG. 3A to the view depicted in FIG. 3B. The rate of the transition may be dependent upon the force level applied by the user if so configured in the software of the present invention. The amount of zoom may be dependent upon the duration of the finger contact, alone or in combination with the applied force level, if so configured in the software of the present invention.

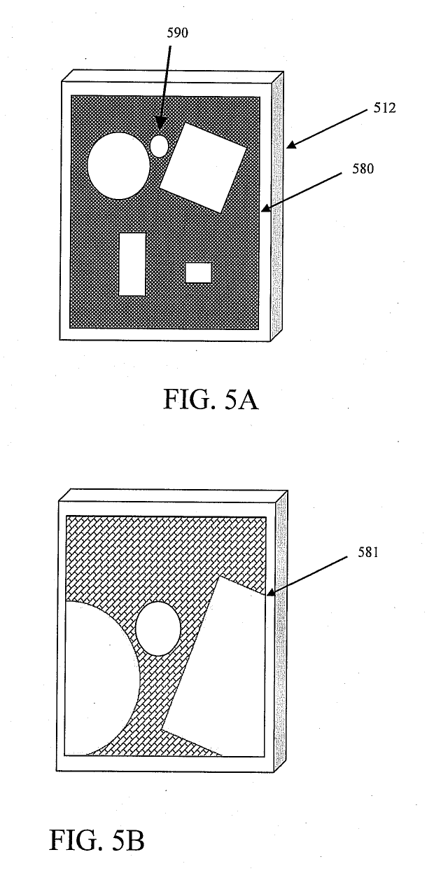

“Focal point,” as used herein, refers to the location upon the document that is being zoomed-towards. In other words, it is the point in the document that is being approached as the document is brought closer. In FIGS. 3A and 3B, this focal point is the center of the document (i.e., the center of the planet earth). Some embodiments of the present invention enable the user to select and/or control the focal point of the zoom-in function in addition to controlling the amount of zoom-in and/or the speed of the zoom-in function. For example, the location upon behind screen manual control to which the user applies finger pressure may be used by the software to define and/or select and/or adjust the focal point of the zoom-in function. Such an embodiment is described below with respect to FIGS. 5A and 5B.

FIGS. 5A and 5B illustrate the zoom-in function according to at least one embodiment of the invention. Thus in some embodiments of the present invention, the point that is being zoomed-in towards (i.e. the focal point of the zoom-in function) is a location within a currently displayed document that is displayed substantially in front of the location at which the user engages the behind-screen manual control when initiating a zoom-in function. With respect to FIG. 5A, a document is displayed upon display screen 580 of portable computing device 512. The system is enabled by software of the present invention to zoom-in the displayed document in response to the user pressing upon the behind-screen manual control with a finger that applies a force that is above a certain threshold amount of force. In addition, the software is configured to define the focal point of the zoom as the location within the displayed document that is in front of the user's finger contact location at the moment that the zoom-function is enabled. At the time that the zoom-in begins, the focal point is defined as a location within the displayed document that is substantially in front of the user's behind-screen finger contact location. For example, with respect to the portable computing device 512 shown in FIG. 5A, the user may press upon the behind screen manual control at a location that is directly behind screen location 590. At this time, the zoom-in function is initiated. The focal point for the zoom-function is defined as the point in the document that corresponds to screen location 590. As the user presses upon the behind screen manual control, causing the document to zoom-in, the software enlarges the displayed document, approaching toward the defined focal point. The document is displayed as shown in FIG. 5B at future moment in time. As shown, the document has been zoomed-in upon such that focal point of the zoom is that location in the document that corresponded to screen location 590 at the time when the zoom was initiated.

Thus, when comparing the portion of the document displayed upon the screen 580 of FIG. 5A with the portion of the document displayed upon screen 581 of FIG. 5B, the document has zoomed-in towards a location within the document that corresponds with location 590 (i.e., the location in front of where the user pressed when initiating the zoom-in function). This enables a very natural and intuitive way to zoom-in towards a particular focal point within a given document.

In some embodiments of the present invention, only a local portion of the displayed document is caused to zoom in when the user presses upon the behind-screen manual control, that local portion corresponding to an area of the display screen that is in front of the user's finger (or substantially in front of the user's finger) as he or she presses upon the real surface. In some such embodiments, the displayed document is deformed such that the area substantially in front of the user's finger is expanded (i.e., zoomed) while other areas are compressed. In some such embodiments, the displayed document is made to seem like an elastic sheet, the user pressing upon the elastic sheet from behind, thereby stretching (i.e., zooming) the area he or she is pressing upon.

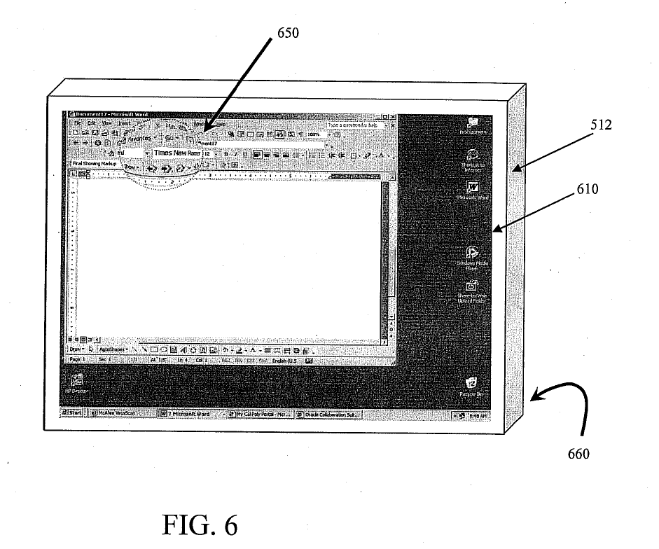

FIG. 6 illustrates a local zoom feature using an elastic screen metaphor and a behind screen interface according to at least one embodiment of the invention. As shown, the user holds a portable computing device 512 that is equipped with the methods and apparatus of the present invention. The computing device displays a graphical user interface upon the frontal surface screen 610. The computing device has a behind-screen manual control located upon the rear surface 660. The behind screen manual control is a touch pad style interface that tracks finger location and pressure within a planar area that corresponds with the screen area as described previously. The user may thus press upon the behind screen manual control at a range of locations behind the displayed content upon screen 610. In this particular embodiment, when a user applies a finger pressure upon the behind screen manual control at a particular location and with a particular pressure, the software causes a local area of the displayed content that is displayed substantially in front of the behind-screen contact location to zoom-in using an elastic sheet metaphor. More specifically, when a user applies a finger pressure upon the behind screen manual control at a particular location and with a pressure that exceeds a certain threshold and/or for a duration that exceeds a certain amount of time, the software causes a local area of the displayed content to stretch as if it were an elastic sheet that was caused to bulge due to pressure from behind at the particular location. The local area is, for example, a circular region that is centered about the behind-screen finger contact location. The size of the circular region may be dependent upon the level of pressure applied from behind, the greater the pressure the larger the circular area. This provides the illusion to the user that he or she is pressing the displayed screen content from behind and by stretching it, causing it to selectively zoom at the finger contact location.

A number of mathematical processes may be used to enable the elastic stretch illusion based upon behind-screen finger pressure. In one example process, a displayed area of the screen content that is substantially in front of the finger contact location is graphically distorted such that it is mapped to the surface of a simulated dome (i.e., half sphere) popping out of the screen, the image content at the top of the dome being expanded and the image content at the edges of the dome being compressed. Such a mapping of image data to a surface of a sphere is known to the art and will not be described in detail herein. The result of such a mapping of a local area of image content is shown in FIG. 6. A local area 650 of the displayed screen content is mapped to a dome surface such that the central portion of the local area 650 is expanded (i.e., zoomed) and the outer portion of the local area is shrunk (i.e., compressed), the local area being centered about the behind-screen finger contact location. The size of the local area 650 is dependent upon the pressure level applied by the users finger upon the behind screen manual control, the higher the pressure the larger the area. This provides the illusion to the user that he or she is pressing the displayed screen content from behind and thereby stretching it, causing it to selectively bulge (i.e., zoom-in) around the user's behind-screen finger contact location. This enables a natural and intuitive method by which a user may selectively view zoomed portions of on-screen graphical content by applying behind screen finger pressure. This also enables the user to selectively perform such a zoom while not blocking the screen with his or her finger.

Some embodiments of the invention handle two-handed interactions. In some embodiments a user may zoom a portion of the on-screen image content, as shown in FIG. 6, by applying behind screen pressure with one hand, and may then use his other hand to select a portion of the zoomed image content by pressing upon the surface of the screen (assuming it has a touch screen interface). In this way the user may select a portion of the zoomed image by (a) using a first hand to apply behind-screen pressure, thereby causing the a portion of the image content to zoom, and (b) using a second hand to apply on-screen pressure, thereby selecting a portion of the zoomed image content. This enables fast and convenient two-handed interactions wherein a user's first hand may engage a behind-screen manual control to selectively zoom the screen and the user's second hand may engage an on-screen manual control to select and/or manipulated zoomed graphical elements. Such a two-handed, behind-screen/on-screen methodology for portable computing devices in which the user's two hands may work together (one on the screen and one behind the screen) to zoom and select graphical elements is a highly powerful benefit of embodiments of the present invention.

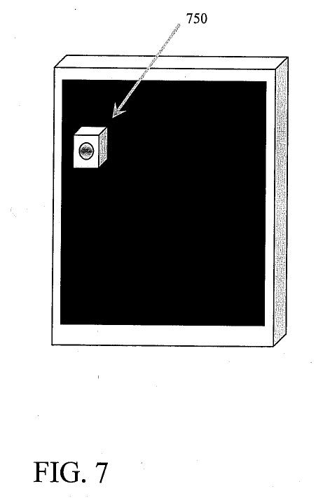

Some embodiments of the invention also utilize various triggering methods. Because a user may accidentally or inadvertently touch the behind screen manual control, a number of methods have been developed to initiate zoom functions only when the behind-screen manual interactions meet one or more defined criteria. In some such embodiments of the present invention, the zoom-in function is only initiated if the user presses upon the behind-screen manual control at a designated location or within a designated area. This location or area may, for example, be located behind a certain displayed graphical element—for example a zoom icon. FIG. 7 illustrates a zoom icon 750 according to at least one embodiment of the invention. The user may zoom some or the entire displayed image content by pressing the zoom icon 750 from behind. In other words, by pressing the behind screen manual control at a location that is substantially behind the displayed location of zoom icon 750. This enables a natural and intuitive method by which a user may selectively view zoomed portions of on-screen graphical content by applying behind screen finger pressure. This also enables the user to selectively perform such a zoom without blocking the screen with his or her finger. In some embodiments a plurality of different zoom icons may be located at a plurality of locations upon the screen and thereby correspond with a plurality of different behind-screen touch locations. In some such embodiments, each of the plurality of icons may correspond with zooming-in upon a different portion of displayed image content.

With respect to the methods that have been developed to initiate zoom functions only when the behind-screen manual interactions meet one or more defined criteria, the user may only zoom-in the document by pressing upon the behind-screen manual control with more than a certain threshold of force according to some embodiments. The user may only zoom-in the document by pressing upon the behind-screen manual control for a time duration that exceeds a certain threshold time in some embodiments. The user may also only zoom-in the document by pressing upon the behind-screen manual control with more than a certain threshold of force and for more than a certain threshold of time according to some embodiments. In some embodiments, the user may only zoom-in upon the document by performing a certain multi-finger gesture upon the behind-screen manual control such as, for example, by pressing with two fingers simultaneously upon the behind-screen manual control. In some embodiments, the user may only zoom-in upon displayed image content based upon a combination of two or more of the force level of the behind-screen interaction exceeding a certain level, the duration of the behind-screen interaction exceeding a certain time limit, the location of the behind-screen interaction being within a certain area, and/or the style of the behind-screen interaction comprising a certain multi-finger configuration.

In some embodiments of the present invention, the amount by which the document is zoomed-in is dependent upon the duration for which the user applies a force upon the behind-screen manual control. The amount by which the document is zoomed-in may be dependent upon the duration for which the user applies a force that is above a certain threshold upon the behind-screen manual control. In some embodiments, the amount by which the document is zoomed-in is dependent upon the level of force applied by the user upon the behind-screen manual control.

Some embodiments of the invention handle behind screen/on-screen interactions. As described above, some embodiments of the present invention enable unique interactions by the user through combined on-screen and behind-screen manual actions. In some such embodiments, the zoom-in functions may be configured through behind-screen manual interactions and zoom-out functions through on-screen manual interactions. This serves as a natural and intuitive paradigm for the user is given the illusion that the document image content is brought closer when he or she presses it from behind, and the document is moved further away when he or she presses if from the front. Thus, the software may be configured to enable zoom-in functions based upon the magnitude, duration, location, and/or type of finger pressure applied upon a behind screen manual control and is configured to enable zoom-out functions based upon the magnitude, duration, location, and/or type of finger pressure applied upon an on-screen manual control (i.e., a touch screen). In some such embodiments the user may zoom-in and zoom-out based upon the difference in pressure applied to a behind-screen manual control and an on-screen manual control. In some embodiments, the direction of the zoom function is dependent upon the difference in pressure applied to a behind screen manual control and an on-screen manual control being greater than a certain threshold. The speed of the zooming function may be dependent upon the difference in pressure applied to a behind screen manual control and an on-screen manual control.

In one such example embodiment, the user may pinch the portable computing device between his thumb and fingers (the thumb being on the frontal surface and the fingers being on the rear-surface) and may zoom in and zoom out based upon the pressure applied to the frontal surface manual control versus the rear-surface manual control. If more pressure is applied to the frontal surface manual control than the rear surface manual control, the software is configured to zoom-out certain displayed document image content. If more pressure is applied to the rear surface manual control than the frontal surface manual control, the software is configured to zoom-in upon certain displayed document image content. In some such embodiments a graphical icon is drawn upon the screen as a reference for where upon both the frontal surface and the rear surface the user is to press to perform the zooming control. Thus with respect to FIG. 7, the frontal surface manual control may be located upon graphical icon 750 such that if a user presses it from in front, one or more images upon the screen will zoom out. In addition the behind screen manual control may be located behind graphical icon 750 such that if a user presses it from behind, one or more images upon the screen will zoom in.

In this way, graphical icon 750 is a unique graphical element that may be engaged by the user from the front (i.e., by touching it from the front using an on-screen manual control) or from behind (i.e., by touching it from behind using a behind-screen manual control) to cause two different actions upon the portable computing device. Such an icon that may be selectively engaged from the front or from behind is a unique and powerful feature. Such an icon may be used to enable selective zoom-in and zoom-out as described herein. Such an icon may be used to enable other features and functions as well.

Other behind screen interactions are also enabled for embodiments of the invention. In some embodiments, a displayed document or displayed object within a document can be tilted upon the screen by pressing upon the behind-screen manual control at one edge of the screen and thereby bringing that edge of the document or object forward, while the opposite edge of the document or object does not come forward. In this way, a document may be selectively tilted forward based upon which edge of the screen is pressed from behind. This is particularly useful if the displayed document is a geographic mapping image that a user wishes to selectively view from various angles.

Behind screen interactions with a displayed virtual globe are also enabled according to some embodiment of the invention. In some embodiments, the displayed imagery upon the screen includes a virtual globe such as the virtual earth generated by Google Earth™ and/or other similar geospatial display applications such as Nasa Worldwind™ and Microsoft Virtual Earth™. For example, the virtual globe may be a three dimensional globe image such as the globe image displayed in FIG. 2A herein. In some such embodiments, the software is configured to enable the user to rotate the globe by swiping his or her finger across it from behind while using a behind-screen manual control. In such embodiments, software causes the displayed globe to rotate upon the screen in the opposite direction to the user's swiping motion as detected by the behind-screen manual control. This provides the user with the illusion that he or she is swiping the back side of the globe and thereby making it rotate. This allows a user to manipulate a virtual globe in a natural and intuitive manner without blocking its view with his or her fingers. In some such embodiments the user may bring the displayed globe closer (i.e., zoom-in upon it) by pressing upon the globe from behind using the behind-screen manual control. In some such embodiments the user may also move the displayed globe farther away (i.e., zoom-out) by pressing upon the globe from the front using an on-screen screen interface such as a touch screen. In this way a user many selectively rotate and zoom a virtual globe using a behind-screen manual control, alone or in combination with an on-screen manual control. In some embodiments a multi-finger behind screen gesture is used to initiate and control the rotate and/or zoom function. For example, two or three fingers pressed simultaneously on the reverse surface of the globe can be configured to cause the rotation and/or zooming function. Also, it should be noted that other three-dimensional objects (other than a virtual globe) may be rotated in place and/or zoomed-in upon using the behind-screen methods described herein. A globe, however, creates a particular effective illusion of behind screen rolling, as if a user is manipulating a real globe from behind as he or she views it from in front.

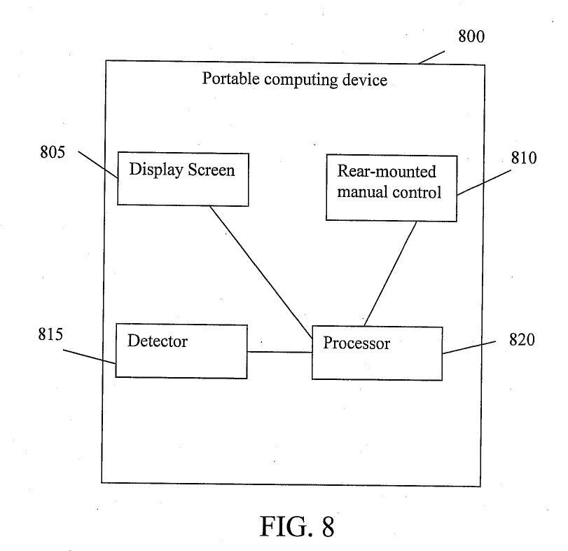

FIG. 8 illustrates a portable computing device 800 for provides behind screen zooming according to at least one embodiment of the invention. A display screen 805 is disposed upon a frontal surface of the portable computing device 800. A rear-mounted manual control 810 is disposed upon a rear surface of the portable computing device 800 and is positioned at a location directly behind at least a portion of the display screen 805 such that a user viewing the display screen 805 while pressing upon the rear-mounted manual control is provided with an illusion of pressing upon the backside of the display screen. A detector 815 detects a finger interaction upon the rear-mounted manual control. A processor 820 enlarges an image displayed upon the display screen in response to and time-synchronized with the detected finger interaction upon the rear-mounted manual control. The enlarging is coordinated with the finger interaction so as to provide an illusion that the user is pushing upon the image from behind.

The foregoing description of preferred embodiments of the present invention provides illustration and description, but is not intended to be exhaustive or to limit the invention to the precise form disclosed.

The foregoing description of preferred embodiments of the present invention provides illustration and description, but is not intended to be exhaustive or to limit the invention to the precise form disclosed. This invention has been described in detail with reference to various embodiments. It should be appreciated that the specific embodiments described are merely illustrative of the principles underlying the inventive concept. It is therefore contemplated that various modifications of the disclosed embodiments will, without departing from the spirit and scope of the invention, be apparent to persons of ordinary skill in the art.

Other embodiments, combinations and modifications of this invention will occur readily to those of ordinary skill in the art in view of these teachings. Therefore, this invention is not to be limited to the specific embodiments described or the specific figures provided. This invention has been described in detail with reference to various embodiments. Not all features are required of all embodiments. It should also be appreciated that the specific embodiments described are merely illustrative of the principles underlying the inventive concept. It is therefore contemplated that various modifications of the disclosed embodiments will, without departing from the spirit and scope of the invention, be apparent to persons of ordinary skill in the art. Numerous modifications and variations could be made thereto by those skilled in the art without departing from the scope of the invention set forth in the claims.

What is claimed is:

1. A method of behind screen zooming for a handheld computing device, the method comprising:
providing a portable computing device with a display screen disposed upon a frontal surface and a rear-mounted manual control disposed upon a rear surface, the rear-mounted manual control being positioned at a location directly behind at least a portion of the display screen such that a user viewing the display screen while pressing upon the rear-mounted manual control is provided with an illusion of pressing upon the backside of the display screen;
detecting a finger interaction upon the rear-mounted manual control; and
enlarging an image displayed upon the display screen in response to and time-synchronized with the detected finger interaction upon the rear-mounted manual control, the enlarging being coordinated with the finger interaction so as to provide an illusion that the user is pushing upon the image from behind, moving it forward toward the frontal surface of the screen in response to pressing upon the rear-mounted manual control.

2. The method of claim 1 wherein an amount of the enlarging is dependent at least in part upon a time duration of the detected finger interaction upon the rear-mounted manual control.

3. The method of claim 1 wherein a speed at which the enlarging is performed is dependent at least in part upon a detected force or pressure level upon the rear-mounted manual control.

4. The method of claim 3 wherein the speed of the enlarging is faster for a higher force or pressure level detected upon the rear-mounted manual control than for a lower force or pressure level.

5. The method of claim 1 wherein the enlarging is dependent upon the detected finger interaction having at least one of a detected force level that is above a threshold level and a detected time duration that is above a threshold duration.

6. The method of claim 1 wherein the enlarging is dependent upon the detected finger interaction being a multi-finger interaction upon the rear-mounted manual control.

7. The method of claim 1 wherein the behind screen manual control is configured as a planar surface that detects a location of user interaction within a detection area, the detection area being positioned at the location that is behind at least a portion of the display screen.

8. The method of claim 7 wherein the image is enlarged such that a portion of the image upon the display screen that is substantially in front of the location of user interaction is maintained substantially in front of the location of user interaction during the enlargement process, while other portions of the image move substantially toward boundaries of the display screen.

9. The method of claim 7 wherein only a local portion of the image upon the display screen is enlarged in response to the detected finger interaction, the local portion being a portion that is substantially in front of the location of user interaction.

10. The method of claim 9 wherein the local portion is enlarged in a manner that appears as if the image is displayed upon an elastic sheet being pressed from behind at the location of user interaction.

11. The method of claim 7 wherein a semi-transparent graphical element is displayed upon the display screen at a repeatedly updated location that is substantially in front of the location of user interaction, thereby enabling the user to view a substantially real-time depiction of the user's finger location upon the rear-mounted manual control.

12. The method of claim 11 wherein the semitransparent graphical element is displayed in an elliptical shape that emulates a shape of finger engagement upon the detection area of the rear-mounted manual control.

13. The method of claim 11 wherein the user interaction is a multi-finger interaction upon the rear-mounted manual control and wherein a plurality of semi-transparent graphical element are displayed, each semi-transparent graphical element being displayed at a screen location that is substantially in front of a separate location of behind-screen finger contact.

14. The method of claim 1 wherein the image comprises at least one of a geographic map and a geospatial image.

15. The method of claim 1 wherein the image is a virtual globe and wherein in response to a user pressing upon the rear-mounted manual control, a visual illusion is provided of a virtual globe coming closer to the user.

16. The method of claim 1 wherein the image rotates upon the display screen in response to a user swiping a finger behind the image upon the rear-mounted manual control.

17. The method of claim 16 wherein the image rotates in a direction that is approximately opposite to a first direction in which the user swiped a finger across the rear-mounted manual control.

18. The method of claim 1 wherein the display screen is a touch screen configured to detect user interactions upon the surface of the touch screen, and wherein the method includes reducing the size of the image displayed upon the display screen in response to a detected finger interaction upon a surface of the screen to create the illusion that a user is pushing the image away from the frontal surface of the display screen while pressing upon the display screen.

19. The method of claim 18 wherein a separate user finger interaction is detected upon each of the rear-mounted manual control and the touch screen at substantially the same time, and wherein the image is zoomed-in or zoomed-out based on a detected force differential between a behind screen interaction and an on-screen interaction.

20. The method of claim 18 wherein the image is zoomed-in in response to a determination that the behind screen finger interaction is applied with greater force than an on-screen finger interaction.

21. The method of claim 18 wherein the image is zoomed-out in response to a determination that an on-screen finger interaction is applied with greater force than a behind screen finger interaction.

22. The method of claim 1 wherein the rear-mounted manual control comprises a touchpad.

23. The method of claim 22 wherein the sensing area of the touchpad is positioned substantially behind the display area of the display screen.

24. A portable computing device for providing behind screen zooming, comprising:
a display screen disposed upon a frontal surface of the portable computing device;
a rear-mounted manual control disposed upon a rear surface of the portable computing device, wherein the rear-mounted manual control is positioned at a location directly behind at least a portion of the display screen such that a user viewing the display screen while pressing upon the rear-mounted manual control is provided with an illusion of pressing upon the backside of the display screen;
a detector to detect a finger interaction upon the rear-mounted manual control; and
a processor to enlarge an image displayed upon the display screen in response to and time-synchronized with the detected finger interaction upon the rear-mounted manual control, the enlarging being coordinated with the finger interaction so as to provide an illusion that the user is pushing upon the image from behind, moving it forward toward the frontal surface of the screen in response to pressing upon the rear-mounted manual control.

25. The portable computing device of claim 24 wherein the processor is adapted to vary an amount of the enlarging at least in part upon a time duration of the detected finger interaction upon the rear-mounted manual control.

26. The portable computing device of claim 24 wherein the processor is adapted to vary a speed at which the enlarging is performed based at least in part upon a detected force or pressure level upon the rear-mounted manual control.

27. The portable computing device of claim 26 wherein the processor is adapted to vary the speed of the enlarging is faster for a higher force or pressure level detected upon the rear-mounted manual control than for a lower force or pressure level.

28. A method of behind screen image manipulation for a handheld computing device, the method comprising:
providing a portable computing device with a display screen disposed upon a frontal surface and a rear-mounted manual control disposed upon a rear surface, the rear-mounted manual control being positioned at a location directly behind at least a portion of the display screen such that a user viewing the display screen while pressing upon the rear-mounted manual control is provided with an illusion of pressing upon the backside of the display screen;
detecting a finger interaction upon the rear-mounted manual control; and
manipulating an image displayed upon the display screen in response to and time-synchronized with the detected finger interaction upon the rear-mounted manual control, the manipulation being coordinated with the finger interaction so as to provide an illusion that the user is manipulating the image from behind, moving the image displayed upon the frontal surface of the screen in response to pressing upon the rear-mounted manual control.

29. The method of claim 28 wherein the image rotates upon the display screen in response to a user swiping a finger behind the image upon the rear-mounted manual control.

30. The method of claim 28 wherein the image rotates in a direction that is approximately opposite to a first direction in which the user swiped a finger across the rear-mounted manual control.

31. The method of claim 28 wherein the rear-mounted manual control comprises a touchpad.

32. The method of claim 31 wherein the sensing area of the touchpad is positioned substantially behind the display area of the display screen.

33. The method of claim 28 wherein the manipulating is dependent upon the detected finger interaction having at least one of a detected force level that is above a threshold level and a detected time duration that is above a threshold duration.

34. The method of claim 28 wherein the manipulating is dependent upon the detected finger interaction being a multi-finger interaction upon the rear-mounted manual control.
